(19) United States
(12) Patent Application Publication
(10) Pub. No.: US 2026/0098506 A1
(43) Pub. Date: Apr. 9, 2026

(54) SYSTEMS AND METHODS FOR CAVITATION PREVENTION ON LINER WALLS

(71) Applicant: Daimler Truck North America LLC, Portland, OR (US)

(72) Inventor: Holger STEFFEN, Waterford, MI (US)

(21) Appl. No.: 19/349,602

(22) Filed: Oct. 3, 2025

Related U.S. Application Data
(60) Provisional application No. 63/704,242, filed on Oct. 7, 2024.

(51) Int. Cl. F02F 1/14; F02F 1/16

(52) U.S. Cl. CPC F02F 1/14; F02F 1/16

(57) ABSTRACT

Systems and methods for cavitation prevention on piston sleeves of an internal combustion (IC) engine are disclosed. An exemplary IC engine includes an engine block including one or more cylinders, and at least one piston sleeve is installed into a respective one of the one or more cylinders, where each piston sleeve receives a corresponding piston. Further, the IC engine includes at least one coolant passageway at least partially formed in the engine block. Furthermore, the IC engine includes at last one cavity formed in the engine block, each of the at least cavity being associated with a respective one of the at least one piston sleeve where the at least one cavity is in fluid communication with the at least one coolant passageway.

### CROSS REFERENCE

The present application claims the priority to and benefit of U.S. Application, No. 63/704,242, which was filed on October 7, 2024. The aforementioned patent application is hereby incorporated by reference in its entirety.

### TECHNICAL FIELD

This present disclosure relates to the field of internal combustion engines, and more particularly, to systems and methods for preventing cavitation degradation on piston sleeve walls in diesel engines.

### BACKGROUND

Internal combustion engines, integral to automotive and industrial sectors, rely on liner walls within the engine block to facilitate essential interactions between a piston and a cylinder of the engine block. These liner walls perform a multifaceted role, crucially guiding the piston's reciprocating motion, containing and sealing high-pressure combustion gases, and effectively dissipating heat generated during engine operation. In diesel engines, known for their efficiency and torque output, these liner walls are subject to intense mechanical stresses and thermal loads, underscoring the critical need for their durability and structural integrity to ensure sustained engine performance and longevity. Beyond their mechanical and thermal roles, the liner walls in diesel engines interface with the coolant circulating within the engine block. The coolant serves pivotal functions, including regulating engine temperature, enhancing thermal management, and preventing overheating under extreme operating conditions. This coolant is typically a mixture of water and antifreeze, designed to maintain stable engine temperatures throughout the entire range of engine speeds and loads.

However, the coolant environment around the liner walls is susceptible to dynamic pressure fluctuations during the engine's combustion cycle. These fluctuations are primarily influenced by the piston's movement and combustion forces. To optimize fuel economy, modem diesel engines increasingly employ larger clearances between the piston and liner to reduce friction, higher peak combustion pressures for enhanced combustion efficiency, and lower coolant pressures to minimize the parasitic load of the coolant pump. While these design optimizations improve overall engine performance, they inadvertently contribute to a heightened risk of cavitation degradation. The interaction between the piston and liner generates rapid pressure changes within the coolant, which can lead to cavitation--a phenomenon that occurs when local pressure in the coolant drops below the vapor pressure, causing bubbles to form and subsequently collapse violently against the liner walls. Over time, this cavitation results in erosive deterioration, such as pitting and surface erosion, undermining the structural integrity and longevity of the liner walls.

### SUMMARY

In some aspects, the techniques described herein relate to an internal combustion engine including: an engine block including one or more cylinders; at least one piston sleeve installed into a respective one of the one or more cylinders, wherein each of the at least one piston sleeve receives a corresponding piston; at least one coolant passageway at least partially formed in the engine block; and at least one cavity formed in the engine block, each of the at least one cavity being associated with a respective one of the at least one piston sleeve, wherein the at least one cavity is in fluid communication with the at least one coolant passageway.

In some aspects, the techniques described herein relate to an internal combustion engine, wherein the at least one cavity is formed in a direction away from the at least one coolant passageway.

In some aspects, the techniques described herein relate to an internal combustion engine, wherein at least a portion of the at least one cavity is located at a radial distance from an outer wall of the at least one piston sleeve.

In some aspects, the techniques described herein relate to an internal combustion engine, wherein the at least one cavity includes a portion that is perpendicular to the at least one coolant passageway.

In some aspects, the techniques described herein relate to an internal combustion engine, wherein the at least one cavity includes a compressible membrane to seal the at least one cavity, such that a portion of the compressible membrane is in fluid communication with the at least one coolant passageway.

In some aspects, the techniques described herein relate to an internal combustion engine, further including a protective membrane placed between the compressible membrane and the at least one coolant passageway.

In some aspects, the techniques described herein relate to an internal combustion engine, wherein the at least one cavity contains a compressible material on a sealed side of the compressible membrane, such that the sealed side is opposite to a side of the compressible membrane that is in fluid communication with the at least one coolant passageway.

In some aspects, the techniques described herein relate to an internal combustion engine, wherein the compressible material is air.

In some aspects, the techniques described herein relate to an internal combustion engine, wherein the at least one cavity is sealed by an expandable membrane, such that a portion of the expandable membrane is in fluid communication with the at least one coolant passageway.

In some aspects, the techniques described herein relate to an internal combustion engine, wherein the at least one cavity includes a plurality of cavities.

In some aspects, the techniques described herein relate to an engine block including: one or more cylinders formed in the engine block, wherein the one or more cylinders receive a respective piston sleeve; at least one coolant passageway at least partially formed in the engine block; and at least one cavity formed in the engine block, each of the at least one cavity being associated with the respective piston sleeve, wherein the at least one cavity is in fluid communication with the at least one coolant passageway.

In some aspects, the techniques described herein relate to an engine block, wherein the at least one cavity is formed in a direction away from the at least one coolant passageway.

In some aspects, the techniques described herein relate to an engine block, wherein at least a portion of the at least one cavity is located at a radial distance from an outer wall of the respective piston sleeve.

In some aspects, the techniques described herein relate to an engine block, wherein the at least one cavity includes a portion that is perpendicular to the at least one coolant passageway.

In some aspects, the techniques described herein relate to an engine block, wherein the at least one cavity is sealed by a compressible membrane, such that a portion of the compressible membrane is in fluid communication with the at least one coolant passageway.

In some aspects, the techniques described herein relate to a method of making an internal combustion engine, the method including: forming a block; forming one or more cylinders in the block; and forming at least one coolant passageway and at least one cavity located a distance away from the one or more cylinders and extending from the at least one coolant passageway.

In some aspects, the techniques described herein relate to a method, further including installing a sleeve in each of the one or more cylinders.

In some aspects, the techniques described herein relate to a method, further compnsmg installing a compressible and/or expandable membrane in the at least one cavity.

In some aspects, the techniques described herein relate to a method, further including placing a protective membrane between the compressible membrane and the at least one coolant passageway.

In some aspects, the techniques described herein relate to a method, wherein forming the at least one cavity includes positioning the at least one cavity inside a defined piston slap range within the engine block.

The foregoing and other objects, features, and advantages of the disclosed technology will become more apparent from the following detailed description, which proceeds with reference to the accompanying figures

### BRIEF DESCRIPTION OF THE DRAWINGS

The examples of the present disclosure are described herein with reference to the accompanying figures. It should be noted that the description and figures relate to exemplary implementations and should not be construed as a limitation to the present disclosure. It is also to be understood that various arrangements may be devised that, although not explicitly described or shown herein, embody the principles of the present disclosure. Moreover, all statements herein reciting principles, aspects, and examples of the present disclosure, as well as specific examples, are intended to encompass equivalents thereof.

FIG. 1 is a rear perspective view of a vehicle, in accordance with the present disclosure.

FIG. 2 is a cross-sectional view of an internal combustion engine of the vehicle, in accordance with the present disclosure.

FIG. 3 is a partial cross-sectional view of a cavitation degradation process on walls of a piston sleeve, in accordance with the present disclosure.

FIG. 4 is an outer perspective view of cavitation degradation on the walls of the piston sleeve, in accordance with the present disclosure.

FIG. 5AandFIG. 5B are cross-sectional views of a cavity in engine block in proximity with the piston sleeve, in accordance with the present disclosure.

FIG. 6 is a side perspective and partial cross-sectional view of the engine block, in accordance with the present disclosure.

FIG. 7 is a top perspective view of the engine block, in accordance with the present disclosure.

FIG. 8 is a flowchart of an example method of making an internal combustion engine, in accordance with the present disclosure.

### DETAILED DESCRIPTION

For the following description, certain specific details are set forth in order to provide a thorough understanding of various disclosed examples. However, one skilled in the relevant art will recognize that examples may be practiced without one or more of these specific details, or with other systems and methods, components, materials, and the like. In other instances, well-known structures, associated with cavitation prevention systems and methods, have not been shown or described in detail to avoid unnecessarily obscuring descriptions of the examples.

Unless the context indicates otherwise, throughout the specification and claims which follow, the word "comprise" and variations thereof, such as, "comprises" and "comprising" are to be construed in an open, inclusive sense that is as "including, but not limited to." Further, the terms "first," "second," and similar indicators of the sequence are to be construed as interchangeable unless the context clearly dictates otherwise.

Reference throughout this specification to "one aspect" or "an aspect" means that a particular feature, structure, or characteristic described in connection with an example is included in at least one aspect. Thus, the appearances of the phrases "in one aspect" or "in an aspect" in various places throughout this specification are not necessarily all referring to the same example. Furthermore, the particular features, structures, or characteristics may be combined in any suitable manner in one or more aspects.

As used in this specification and the appended claims, the singular forms "a," "an," and "the" include plural referents unless the content clearly dictates otherwise. It should also be noted that the term "or" is generally employed in its broadest sense, that is, as meaning "and/or" unless the content clearly dictates otherwise.

As used in this specification and the appended claims, the terms "liner" and "sleeve" may be interchangeably used as both terms describe components that serve similar functions within the engine system Specifically, a "liner" or "sleeve" refers to a cylindrical component that provides a durable, wear-resistant surface for the movement of pistons or other interacting parts. This component protects the underlying engine block or other structural elements from wear and erosion, ensuring consistent performance and longevity. The interchangeable use of "liner" and "sleeve" is intended to encompass all variations of such protective and supportive components within the scope of this disclosure.

Various strategies have been proposed to reduce or eliminate the impact of cavitation on the liner walls of engines. For instance, US11028799B2 describes an anti cavitation engine block assembly designed for liquid-cooled engines. This assembly features multiple cylinders with inter-cylinder wall sections that incorporate anti-cavitation channels axially elongated trenches positioned adjacent to piston sleeves. While this assembly aims to mitigate cavitation during engine operation, several challenges arise. The complexity of manufacturing and integrating these anti-cavitation channels into existing engine block designs without compromising structural integrity or performance is a significant hurdle. Additionally, variations in engine operating conditions, such as temperature fluctuations and coolant flow dynamics, may affect the channels' effectiveness in uniformly mitigating cavitation across different engine configurations. Moreover, the durability and long-term reliability of these channels under continuous engine operation present potential challenges, including material wear and the risk of blockages that could impair functionality over time. Furthermore, optimizing the design and placement of these channels to achieve maximum cavitation resistance while minimizing adverse impacts on engine efficiency remains a critical engineering concern.

Furthermore, other strategies to eliminate or mitigate cavitation-related degradation present their own challenges. One such approach involves optimizing coolant flow dynamics within the engine block through the design of intricate coolant passages and channels. While this approach can enhance circulation and heat dissipation, it often necessitates precise engineering and manufacturing tolerances. Variations in coolant flow patterns and pressures under different engine loads and speeds may still lead to localized cavitation zones, undermining the effectiveness of this strategy. Additionally, integrating these optimized coolant pathways into existing engine designs can escalate production costs and create maintenance complexities throughout the engine's lifecycle. Another potential solution is the use of advanced materials and coatings for piston sleeves to improve resistance to cavitation erosion. While high-strength alloys and specialized coatings can enhance durability, these solutions may not be economically feasible and could add weight to the overall engine assembly. Ultimately, balancing these design choices with the overarching goal of optimizing fuel efficiency and engine performance remains a significant challenge in addressing cavitation risks.

The present disclosure describes various aspects that overcome or address the drawbacks associated with the existing strategies. To effectively reduce the occurrence of cavitation, it is essential to maintain a sufficiently high coolant pressure around the liner, preventing pressure drops during operation that could fall below the vapor pressure of the coolant. Specifically, the aspects of the present disclosure describe various systems and methods aimed at preventing cavitation degradation on engine liner walls caused by coolant pressure changes, through strategic use of entrapped air in a cavity located adjacent to the liner. The aspects disclosed herein address the root causes of cavitation, which includes the impact of piston inside the internal combustion (IC) engine against the liner and the resulting high peak pressure of the coolant during combustion.

In example systems and methods, a cavity is formed near the liner walls, utilizing machining or casting techniques. Within this cavity, air is entrapped to serve as a compressible or expandable membrane to counteract volume changes caused by liner movement. During the engine operation, particularly under conditions of piston impact and combustion events, the entrapped air effectively absorbs pressure fluctuations induced by these mechanical and thermal dynamics, thereby maintaining the dynamic pressure in the coolant above the critical vapor pressure threshold. This proactive measure ensures that no cavitation bubbles are formed, thereby safeguarding the integrity of the liner walls against erosion and degradation over time.

Various aspects within the disclosure enhance the cavitation prevention in engines. One such aspect includes integration of a compressible membrane or an expandable membrane such that a portion of the compressible membrane or the expandable membrane is in fluid communication with at least one coolant passageway to seal the cavity. This membrane preserves the entrapped air, particularly in scenarios where external factors such as vacuum filling of the coolant system might deplete the air volume. Another aspect includes the optimization of cavity geometry and placement, ensuring optimal air entrainment and pressure absorption characteristics tailored to specific internal combustion engine designs and operational conditions.

Accordingly, aspects of the present disclosure represent a significant advancement in internal combustion engine technology, offering a proactive solution to mitigate cavitation degradation through strategized cavity design and entrapped air utilization. This methodological approach underscores the commitment to enhancing internal combustion engine durability, efficiency, and reliability in response to evolving performance demands and environmental considerations in the automotive and industrial sectors. These and other advantages of the present disclosure are provided in greater detail in subsequent paragraphs.

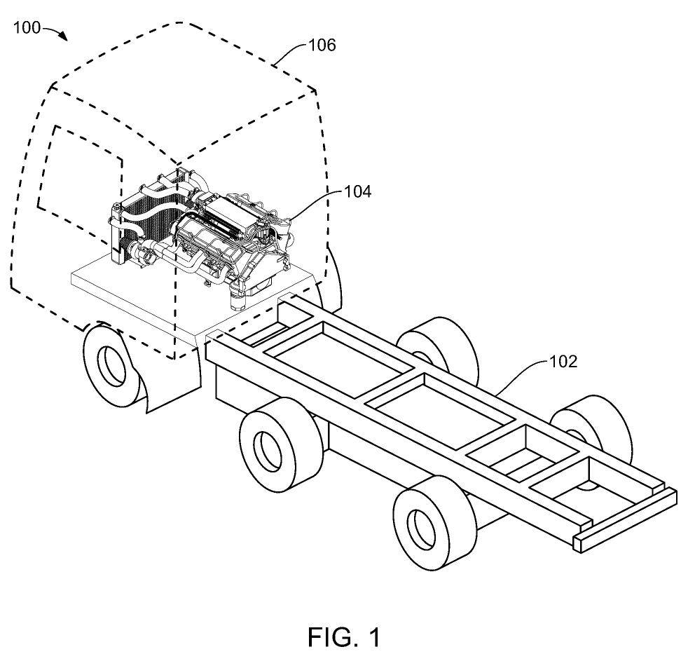

Referring to FIG. 1, a vehicle 100, in accordance with an aspect of the present disclosure, comprises a chassis 102, an internal combustion engine 104, and a cab 106. In an aspect, the vehicle 100 may be a heavy vehicle. The heavy vehicle may be categorized from class 1 to class 8. Class 1 may include vehicles that weigh 6000 pounds (lbs.) and less such as but may not be limited to minivans, cargo vans, sports utility vehicles (SUVs), and pickup trucks. Class 2 may include vehicles that weigh between 6001 lbs. to 10000 lbs. such as but may not be limited to minivans, cargo vans, full-size pickup vehicles, and step vans. Further, class 3 may include vehicles that weigh between 10001 lbs. to 14000 lbs. such as but may not be limited to walk-in vehicles, box trucks, city delivery vehicles, and heavy-duty pickup vehicles. Class 4 may include vehicles that weigh between 14001 to 16000 lbs. such as but not may not be limited to large walk-in trucks, box trucks, and city delivery trucks. Class 5 may include vehicles that weigh between 16001 lbs. to 19500 lbs. such as but may not be limited to bucket trucks, large walk-in vehicles, city delivery buses, and the like. Class 6 may include vehicles that weigh between 19501 to 26000 lbs. such as but may not be limited to beverage trucks, school buses, single-axle, and rack trucks. Class 7 may include vehicles that weigh between 26001 to 33000 lbs. such as but may not be limited to refuse, furniture carrying truck/buses, city transit buses, and truck tractors. Also, class 8 may include vehicles that weigh 33001 lbs. and more such as but may not be limited to dump trucks, sleeper, cement trucks, truck tractors and the like.

In aspects, the vehicle 100 may be designed for applications such as transportation and hauling. In addition, the vehicle 100 may take the form of another passenger or commercial automobile such as, for example, a car, a performance vehicle, a truck, a crossover vehicle, a van, a minivan, a taxi, a bus, etc., and may be configured and/or programmed to include various types of automotive drive systems. Examples of drive systems include but are not limited to internal combustion engine (ICE) powertrains having a gasoline, diesel, hydrogen, or natural gas-powered combustion engine with conventional drive components such as a transmission, a drive shaft, and a differential.

Further, the vehicle 100 may be a manually driven vehicle, and/or be configured and/or programmed to operate in a fully autonomous (e.g., driverless) mode (e.g., Level 5 autonomy) or in one or more partial autonomy modes which may include driver assist technologies.

In aspects, the chassis 102 of the vehicle 100 may provide a foundational structure upon which other components of the vehicle 100 may be mounted and integrated. The chassis 102 may include a robust framework designed to withstand heavy loads and provide stability during the transportation and the hauling operations performed by the vehicle 100. The chassis 102 may include longitudinal frame rails and cross members. The longitudinal frame rails and cross members may collectively define the shape and structure of the vehicle 100 and may be required to meet a pre-defined safety standard set by the manufacturer. Further, the longitudinal frame rails and cross members may develop operational requirements typical of the heavy vehicles classified within the above-mentioned classes 1 to 8, corresponding to the vehicle 100.

In an aspect, the chassis 102 may comprise a structured assembly of high-strength materials, such as steel alloys or composite materials, strategically designed to optimize strength-to-weight ratio while accommodating the payload requirements of the vehicle 100. The design considerations may include the longitudinal and transverse frame members, cross members, and reinforcement sections configured to distribute loads effectively throughout the structure of the chassis 102. The chassis 102 may incorporate mounting provisions and attachment points for securely affixing various vehicle subsystems and components, including but not limited to the internal combustion engine 104 (also referred to as the internal combustion engine 104), the cab 106, a suspension system, a fuel tank, an exhaust system, and drivetrain components. These mounting provisions may strategically be positioned to enhance structural integrity and minimize vibrations, contributing to improved ride comfort and operational efficiency. Moreover, the chassis 102 may be configured to accommodate various suspension configurations, including but not limited to leaf spring, coil spring, air suspension, or torsion bar systems, tailored to optimize ride quality, handling characteristics, and load carrying capacity based on the vehicle's intended application and operational requirements.

The internal combustion engine 104 may be mounted onto the chassis 102 and positioned in a forward section of the chassis 102. The internal combustion engine 104 may be responsible for converting fuel energy into mechanical power or propel the vehicle 100 across varied terrains and operational conditions. In accordance with the present disclosure, the internal combustion engine 104 may encompass a diverse range of internal combustion engine configurations tailored to meet specific performance, efficiency, and regulatory requirements applicable to heavy-duty transportation applications. In an example, the internal combustion engine 104 may include a conventional diesel engine effective for its robust torque output and fuel efficiency characteristics ideal for long-haul transport and heavy payload capacities. Alternatively, or additionally, the internal combustion engine 104 may feature a gasoline powered variant, offering enhanced acceleration and responsiveness suitable for urban delivery and shorter distance operations within the heavy vehicle classification spectrum from class 1 to class 8.

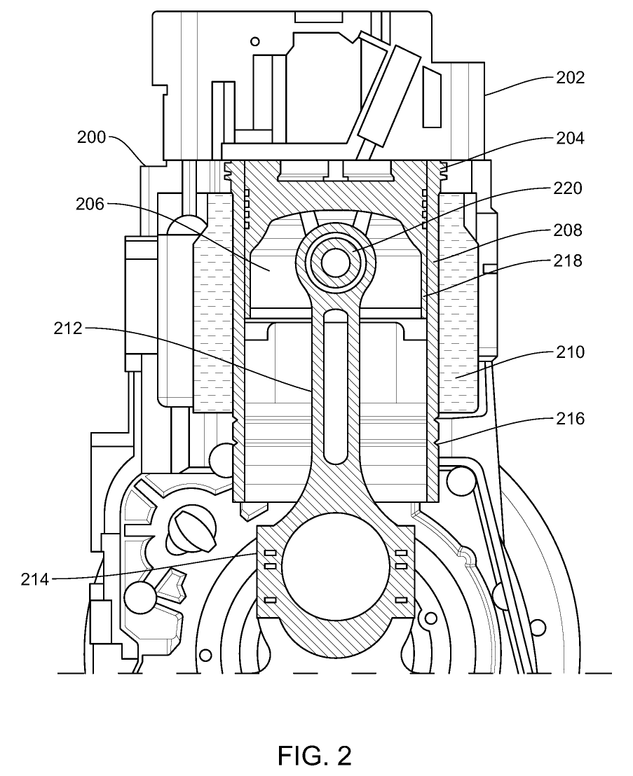

Further, the internal combustion engine 104 may include an engine block which may be a sturdy, cast-iron or aluminum alloy housing that includes multiple cylinders arranged in configurations such as inline, V-shaped, or horizontally opposed layouts, depending on the specific internal combustion engine type and manufacturer specifications. The components of the internal combustion engine 104 are explained in detail with reference to FIG. 2. The engine block may provide structural support and may house components including the cylinders, pistons, and crankshaft. Each cylinder within the engine block may house a piston connected to a crankshaft via connecting rods. During operation, the downward movement of the piston within each cylinder may compress an air-fuel mixture, while the upward movement of the piston may expel exhaust gases after combustion of the air-fuel mixture. This reciprocating motion of the piston may convert linear motion into rotary motion, which drives the vehicle 100's transmission system, thereby propelling the vehicle 100 forward or backward.

The internal combustion engine 104 may incorporate a cylinder head assembly situated atop the engine block. The cylinder head may house intake valves and exhaust valves, which may be actuated by camshafts and associated valve mechanisms in the internal combustion engine 104. These components may precisely regulate the flow of air-fuel mixture into a combustion chamber of the internal combustion engine 104 where the combustion and the expulsion of exhaust gases occur. The engine block may include a piston sleeve within each cylinder. In some aspects, the piston sleeve may form an inner wall of the engine block and provide a smooth, wear-resistant surface for the reciprocating motion of the piston. The piston sleeve may be made from durable materials such as cast iron or alloyed steel, selected for their ability to withstand high temperature, pressure, and mechanical wear over prolonged use. The piston sleeve, in some aspects, may be precision-machined to ensure proper piston fitment and alignment within the engine block, maintaining optimal compression ratios and minimizing friction losses during engine operation.

In some aspects, the internal combustion engine 104 may integrate a fuel delivery system to administer precise fuel dosages based on real-time operating parameters of the internal combustion engine 104. The fuel delivery system may include fuel injectors that atomize and inject fuel directly into each cylinder of the engine block under high pressure, for combustion. High-pressure fuel pumps may maintain optimal fuel pressure, while electronic control modules (ECMs) may monitor and adjust fuel delivery, ignition timing, and other parameters to optimize fuel economy, emission compliance, and engine reliability across diverse operating conditions.

Further, the internal combustion engine 104 may include a cooling system for managing thermal conditions generated during combustion. The cooling system may include a plurality of passageways for coolant at least partially formed in the engine block. Suitable examples of a coolant passageway include, but are not limited to, any channel, duct, or conduit formed in or around the engine block for the purpose of circulating coolant fluid to regulate engine temperature. The cooling system may include a radiator, a coolant, a surge tank, a water pump, and hoses. The surge tank acts as a coolant reservoir and the coolant may circulate through passages within the engine block and the cylinder head, absorbing heat and transferring it to a radiator where excess heat may be dissipated into the surrounding air.

The internal combustion engine 104 may incorporate auxiliary components such as but not limited to turbochargers or superchargers to increase intake air pressure. The turbochargers may compress incoming air before it enters the cylinders of the engine block, thereby boosting power output without compromising fuel efficiency. Further, the turbochargers may utilize the exhaust gases to drive a turbine that compresses intake air, while the superchargers are mechanically driven by the crankshaft inside the internal combustion engine 104.

The cab 106 may be attached to a rear portion of the chassis 102. The cab 106 may serve as a compartment for a driver of the vehicle 100 and passengers. The cab 106 may include features which may not be limited to windows, doors, mirrors, and a windshield. The cab 106 may be connected to the chassis 102 through a plurality of mounting points, allowing for stability and structural integrity. In addition, the cab 106 may be designed to provide comfort and protection to passengers, with ergonomic considerations taken into account for ease of use during operation.

Referring to FIG. 2, which will be explained in conjunction with the description of FIG. 1, in an aspect, the internal combustion engine 104 includes an engine block 200, a cylinder head 202, an upper flange 204, a piston 206, at least one piston sleeve 208, at least one coolant passageway 210, a connecting rod 212, a crankshaft 214, piston sealing rings 216, a piston skirt 218, and a piston pin 220.

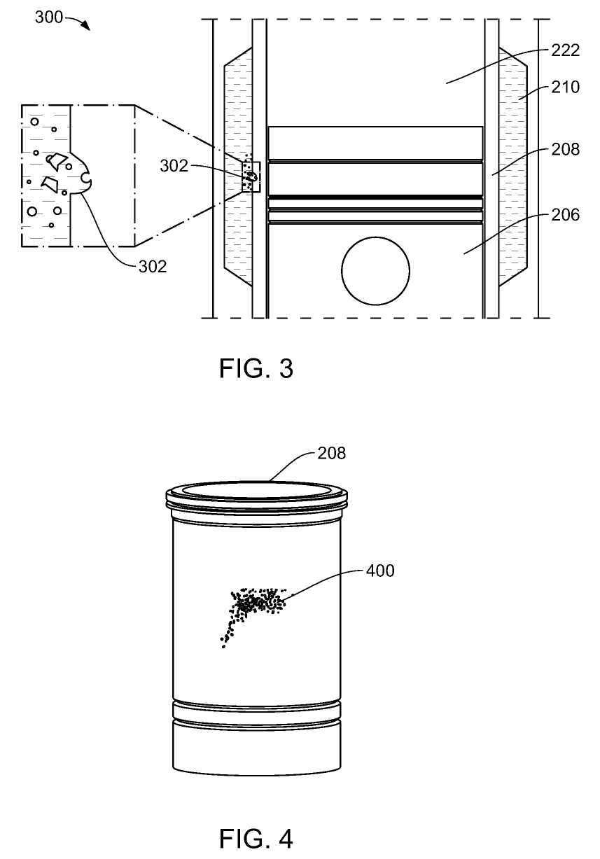

In general, the engine block 200 may house multiple cylinders where pistons (e.g., piston 206) reciprocate to generate mechanical power. In aspects, the cylinder head 202 may be positioned atop the engine block 200. The cylinder head 202 may form an uppermost part of a combustion chamber 222 (shown in FIG. 3). The cylinder head 202 may house an inlet valve and an exhaust valve for controlling the flow of air-fuel mixture and exhaust gases inside the combustion chamber 222. In an aspect, the cylinder head 202 may be secured to the top of the engine block 200 via head bolts/studs and a head gasket, ensuring a tight seal. The cylinder head 202 may facilitate the combustion by sealing the top of the engine block 200, housing the inlet valve and the exhaust valve that may regulate the intake of air-fuel mixture and the exhaust of combustion gases. The cylinder head 202 may include coolant passages for maintaining optimal operating temperatures. The coolant passages allow the coolant to be circulated inside the engine block 200 and further transmitted to a radiator and/or another type of heat exchanger to remove heat from the engine block 200 and/or the at least one piston sleeve 208.

The upper flange 204 may be machined as a part of the engine block 200, extending outward to provide a flat surface for mounting components. The upper flange 204 may provide a mounting surface and structural support for attaching ancillary components which may not be limited to the cylinder head 202, intake manifold, and other engine peripherals. In an aspect, the combustion chamber 222 may form a sealable unit in some aspects, when attached to the engine block 200. The combustion chamber 222 may be where the air-fuel mixture is ignited. Further, the combustion chamber 222 may accommodate the movement of the piston 206 and facilitate controlled combustion.

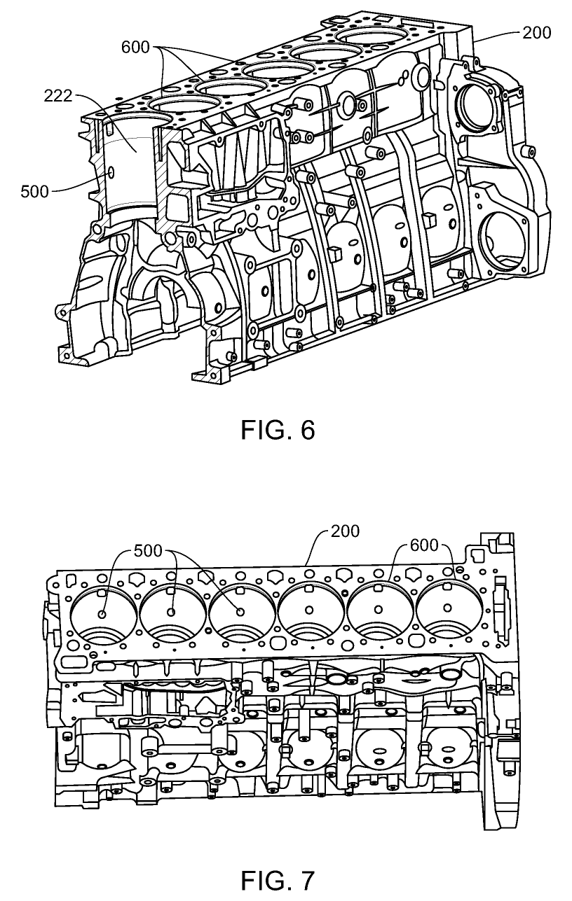

In an aspect, the piston 206 may be directly housed within a cylinder bore of the engine block 200. The engine block 200, as shown in FIG. 6 later, may include one or more cylinder bores designed to accommodate various components of the internal combustion engine 104. The engine block 200 may include one or more cylinders inside each of one or more cylinder bores. The one or more cylinder bores may be precisely machined within the engine block 200 to house the one or more cylinders. Each cylinder within the cylinder bores serves as a chamber where combustion occurs. The piston 206 may move up and down within the cylinder bore in response to the combustion forces. In operation, the piston 206 may convert the energy from the combustion into mechanical motion, transmitting force to the connecting rod 212 and subsequently to the crankshaft 214, which may drive a transmission system to transmit power from the internal combustion engine 104 to the wheels while allowing for varying speeds and torque through different gear ratios.

The connecting rod 212 may connect the piston 206 to the crankshaft 214. Specifically, one end of the connecting rod 212 may be attached to a piston pin of the piston 206, while the other end may be connected to the crankshaft 214. The connecting rod 212 may transmit the reciprocating motion of the piston 206 to the rotational motion of the crankshaft 214. Further, the connecting rod 212 may convert linear motion of the piston 206 into the rotational motion of the crankshaft 214, enabling the piston 206 to drive the crankshaft 214. The piston 206 may ensure smooth operation of the internal combustion engine 104 under varying loads and speeds of the vehicle 100.

In an aspect, the at least one piston sleeve 208 may be installed into a respective one of the one or more cylinders, where each of the at least one piston sleeve 208 receives a corresponding piston 206. The at least one piston sleeve 208 may fit snugly into each cylinder bore of the engine block 200 and sealed to prevent leakage and maintain compression within the cylinders. In aspects, the at least one piston sleeve 208 may protect the engine block 200 from wear and corrosion, enhancing piston sealing, and facilitating efficient heat dissipation.

The at least one coolant passageway 210 may be at least partially formed in the engine block 200. Additionally, the at least one coolant passageway 210 may be at least partially located at a radial distance. The coolant in the at least one coolant passageway 210 may manage thermal conditions to ensure optimal performance and longevity of the internal combustion engine 104 including but not limited to the at least one piston sleeve 208. In an example, the at least one coolant passageway 210 may include a coolant composed of a mixture of water and antifreeze (ethylene glycol or propylene glycol). In another example, the coolant may include ethylene glycol (95%), water and corrosion inhibitors such as silicates, phosphates, and organic acids. The coolant in the at least one coolant passageway 210 may circulate throughout the cooling system of the internal combustion engine 104, absorbing heat generated during the combustion and dissipating the heat.

During operation of the internal combustion engine 104, the coolant in the at least one coolant passageway 210 may absorb heat from walls of the engine block 200 and carry the heat to a radiator, where the excess heat is released into the surrounding air through convection. The continuous cycle of heat absorption and dissipation may help maintain the internal combustion engine 104 at a stable operating temperature, typically around 195-220 degrees Fahrenheit (90-105 degrees Celsius), which may be optimal for the performance of the internal combustion engine 104. In general, the cooling system of the internal combustion engine 104 may be equipped with various components to ensure efficient coolant circulation, including a pump that may propel the coolant in the at least one coolant passageway 210 through the engine block 200, a thermostat that regulates the temperature of the coolant in the at least one coolant passageway 210 flow based on a predetermined set temperature, and the radiator that may facilitate heat exchange with the environment. In addition, the piston sealing rings 216 may fit tightly around the piston 206 within each cylinder bore of the engine block 200 to provide a proper seal. The piston sealing rings 216 may maintain compression within the cylinder by preventing gas leakage and may regulate lubricating oil distribution along the walls of the engine block 200.

Referring to FIG. 3, a cavitation degradation process 300 on walls of the at least one piston sleeve 208, according to an example of the present disclosure, will be explained in conjunction with the description of FIG. 1 and FIG. 2. In an aspect, the engine block 200 (FIG. 2)includes a cavitation impacted portion 302, the piston 206, the at least one piston sleeve 208, the at least one coolant passageway 210, and the combustion chamber 222.

In an aspect, degradation on the walls of the at least one piston sleeve 208 may primarily be caused by mechanical interactions between the piston 206 and the at least one piston sleeve 208 during operation of the internal combustion engine 104. During operation, the internal combustion engine 104 may begin with an intake stroke, where a mixture of air and fuel is drawn into the combustion chamber 222. Subsequent compression of this mixture by the piston 206 during the compression stroke may raise its pressure and temperature for ignition process. The ignition process, whether sparked by a spark plug in gasoline engines or by compression in the internal combustion engine 104, may initiate rapid combustion, generating high temperatures and pressures that drive the piston 206 downward in a power stroke. This mechanical energy may then be transferred to the crankshaft 214, where it may be converted into rotary motion to propel the vehicle 100. Exhaust gases may be expelled during the exhaust stroke, completing the cycle.

In accordance with the present disclosure, during the combustion event the piston 206 might tilt around the piston pin 220, causing the piston skirt 218 to impact the liner in an event called piston slap. This might result in a lateral movement of the cavitation impacted portion 302, causing a volume change in the at least one coolant passageway 210. The cavitation impacted portion 302 initially moves towards the at least one coolant passageway 210, causing a pressure rise. The rebound movement of the cavitation impacted portion 302 towards the inside of the liner causes a pressure drop in the at least one coolant passageway 210. If the pressure of the at least one coolant passageway 210 drops below the vapor pressure at current temperature, which varies with operating conditions of the internal combustion engine 104 operating conditions, a plurality of gas bubbles may form within the at least one coolant passageway 210.

The plurality of gas bubbles, initially stable, may pose a significant risk when the area of the cavitation impacted portion 302 moves outwards again after the first rebound movement. This causes the pressure in the at least one coolant passageway 210 to increase again rapidly. The rapid increase in the pressure may exceed the collapse strength of the plurality of gas bubbles formed during the previous lateral movement of the impacted area of the liner wall . In an aspect, the plurality of bubbles may release energy in the form of micro jets when the plurality of bubbles collapse near the walls of the at least one piston sleeve 208. The formation of the micro jets is exemplified through the cavitation impacted portion 302. The micro jets may have erosive properties that may gradually degrade the metal surface of the at least one piston sleeve 208 over repeated cycles of the internal combustion engine 104.

In an aspect, an intensity and a frequency of cavitation events may be influenced by a plurality of factors which may not be limited to design and operation of the internal combustion engine 104. In addition, the clearance or gap between the piston 206 and the at least one piston sleeve 208 may determine the force with which the piston 206 impacts the at least one piston sleeve 208 during piston slap. In an example, a larger clearance may result in a more impactful force, leading the potential for larger cavitation degradation. Additionally, the maximum combustion pressure generated within the engine block 200 during the power stroke may directly correlate with the magnitude of the pressure changes experienced by the at least one coolant passageway 210.

Referring to FIG. 4, a cavitation degradation 400 on walls of the at least one piston sleeve 208 is, for example, formed as a result of multiple impacted portions such as the cavitation impacted portion 302 described above.

The cavitation degradation 400, when progressing through the walls of the at least one piston sleeve 208, may cause a substantial degradation of the internal combustion engine 104. In an example, the cavitation degradation 400 may create a leak path for the at least one coolant passageway 210 at a bottom of the cavitation impacted portion 302 towards an oil pan or towards the combustion chamber 222 of the internal combustion engine 104, which may contaminate lubricating oil and cause engine wear or cause a hydraulic lock if leaking into the combustion chamber 222. As previously described, the cavitation degradation 400 may be formed due to the collapse of the plurality of gas bubbles formed from the at least one coolant passageway 210, resulting in high velocity microjets impacting the inner surfaces of the at least one piston sleeve 208. In addition, the cavitation degradation 400 may form a series of pits and erosive channels that may penetrate into the material of the at least one piston sleeve 208. Beyond compromising the functionality of the at least one piston sleeve 208, the cavitation degradation 400 may necessitate costly repairs or replacements to restore operational reliability.

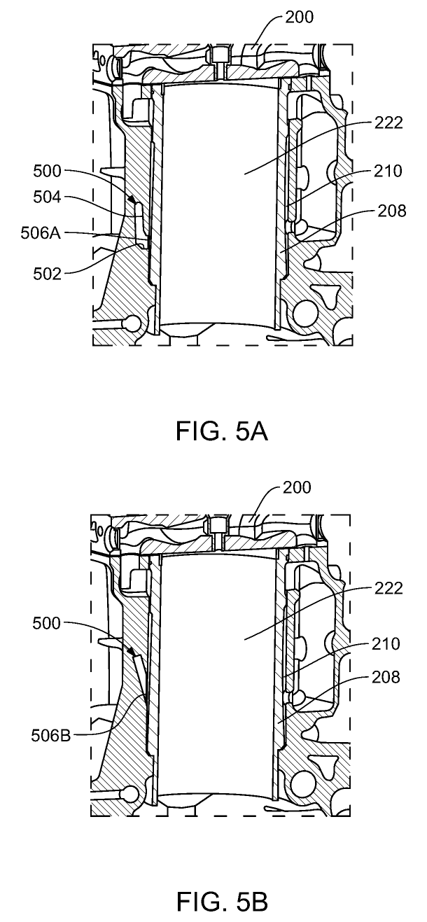

Referring to FIG. 5AandFIG. 5B, at least one cavity 500 in the engine block 200 is located in proximity with the at least one piston sleeve 208 to prevent the cavitation degradation 400, according to an example of the present disclosure. It is to be understood that the cavity (e.g., 500) includes a compressible material, for example air or other material (e.g., carbon graphene monolith). The compressible material reduces or avoids volume and pressure changes in the coolant passages, thereby reducing or avoiding cavitation. FIG. 5AandFIG. 5B will be explained in conjunction with the previous figures. As such, suitable examples of the at least one cavity 500 include, but are not limited to, any void, chamber, or hollow space formed in the engine block 200, which may be created by machining, casting, or other means, and which may be configured to contain a compressible or expandable medium for the purpose of absorbing pressure fluctuations. The at least one cavity 500 may be a plurality of cavities. Each of the one or more cylinders in the engine block 200 may have at least one of the plurality of cavities 500 at least partially located at a radial distance from an outer wall of the at least one piston sleeve 208 . Additionally, at least a portion of the at least one cavity 500 may be located at a radial distance from an outer wall of the at least one piston sleeve 208.

In an aspect, the at least one cavity 500 may be formed within the engine block 200. Each of the at least one cavity 500 may be associated with a respective piston sleeve 208, such that each of the at least one cavity 500 is in fluid communication with the corresponding coolant passageway 210. The maximum distance between the cavitation impacted portion 302 and an edge of air cavity in the at least one cavity 500 may depend on the frequency of movement of the at least one piston sleeve 208 from the piston slap. In general, the piston slap may occur when the piston 206 hits against walls of the at least one piston sleeve 208. In an aspect, the point of piston slap may vary as a function of engine operating conditions, resulting in a defined piston slap range during the operation of the internal combustion engine 104. As such, the piston slap range includes the spatial region within the engine block or cylinder where the piston is likely to impact or come into close proximity with the liner or sleeve during operation, particularly under conditions that induce lateral piston movement, leading to cavitation degradation. To effectively prevent or handle the cavitation degradation, the at least one cavity 500 may be strategically positioned inside the defined piston slap range within the engine block 200. By placing the at least one cavity 500 in proximity to the defined piston slap range, the engine block 200 may absorb mechanical energy generated during a number of piston slaps, thereby reducing pressure fluctuations in the at least one coolant passageway 210. The targeted placement of the at least one cavity 500 may not only enhance the cooling efficiency but also minimizes the risk of cavitation-related degradation on the liner walls, promoting overall engine reliability and longevity.

Additionally, the pressure wave from the movement of at least one piston sleeve 208 may have to reach the air pocket of the at least one cavity 500 faster than the local pressure rise at the at least one piston sleeve 208. This may reduce the height of amplitude of the pressure wave. In an example, if the movement or frequency of the at least one piston sleeve 208 is at 1000 Hertz, the duration of the rebound movement from its outwards peak back to the original position may be about 0.25 milliseconds. Additionally, the pressure wave moves within the at least one coolant passageway 210 at the speed of sound. The at least one coolant passageway 210, usually a mixture of 50% alcohol (speed of sound 1200 m/s) and 50% water (1500 m/s) may mean that the speed of sound is approximately 1350 m/s. As a result, the pressure wave may travel at approximately 33 centimeters within a duration of 0.25 ms. Consequently, the edge of the air pocket in the cavitation impacted portion 302 may not be further away than about 33 centimeters (e.g., between about 20 centimeters and about 40 centimeters) from a center of the movement of the at least one piston sleeve 208 to have an effect on the pressure at the at least one piston sleeve 208.

Referring to FIG. 5A,in an exemplary aspect, at least one cavity 500 is formed in a direction away from the at least one coolant passageway 210. Note that FIG. 5AandFIG. 5B exhibit exemplary configuration, position, and size of the at least one cavity 500 and are not to be construed as limiting to the exemplified aspects. In an exemplary aspect, the at least one cavity 500 may include a portion 502 that is perpendicular to the at least one coolant passageway 210. The perpendicular is defined with respect to a vertical axis around which the at least one coolant passageway 210 wraps, allowing the at least one cavity 500 to extend radially outward from the at least one coolant passageway 210. Such a design may facilitate enhanced energy absorption from the piston slap impacts while maintaining proximity to the coolant flow, thereby optimizing thermal management in the engine block 200. In an exemplary aspect, the at least one cavity 500 may include another or additional portion 504 that may be formed at an angle that is inclined towards a top of the engine block 200 from the at least one coolant passageway 210. In aspects, the additional portion 504 may be above an opening of the at least one cavity 500 so that air may get entrapped when the internal combustion engine 104 gets filled with the coolant.

Further, the at least one cavity 500 may include a first compressible membrane 506A, such that a portion of the first compressible membrane 506A is in fluid communication with the at least one coolant passageway 210. In other aspects, the at least one cavity 500 may be sealed by an expandable membrane from the at least one coolant passageway 210. In an example, the first compressible membrane 506A may be formed of rubber. In another example, the first compressible membrane 506A may be formed of silicon. In yet another example, the first compressible membrane 506A may be formed by any of polyethylene, polyvinyl chloride or thermoplastic elastomers. Suitable examples of the membrane 506A, which can be compressible and/or expandable, include but are not limited to a flexible, resilient barrier or film that can deform under internal or external pressure, used to seal a cavity while allowing for volume changes due to pressure fluctuations.

In further aspects, a protective membrane may further be placed between the first compressible membrane 506A and the at least one coolant passageway 210. The protective membrane may serve as an additional layer of defense between the first compressible membrane 506A and the at least one coolant passageway 210. The protective membrane may be constructed from a durable material resistant to thermal degradation and chemical corrosion, ensuring that the protective membrane maintains integrity under the high temperatures and pressures typical within the internal combustion engine 104. The protective membrane may act as a barrier to prevent the coolant from degrading the first compressible membrane 506A, thereby enhancing the longevity of both components. In aspects, the first compressible membrane 506A includes an integral protective membrane as a part thereof, which serves to contact coolant.

In aspects where no compressible membrane is used, the at least one cavity 500 may be placed upwards as depicted in FIGS. 5A and 5B. In such aspects, when the internal combustion engine 104 is filled with the coolant in the at least one coolant passageway 210, the coolant is filled until some of the coolant just enters the air pocket of the at least one cavity 500, which leaves the air inside to act as the compressible material. Further, when no compressible membrane is used, no vacuum is used to remove air from coolant lines prior to adding the coolant, as this would remove air (i.e., compressible material) from the cavity. In aspects where no compressible membrane (e.g., 506A) is used, the at least one cavity 500 may not be angled downwards with respect to the at least coolant passageway 210, as coolant could then flow into the cavity via gravity and eliminate any advantage of having the cavity in the first place. Only when a compressible membrane (e.g., 506A) is used, can the cavity extend downwards since air can still be trapped therein due to the coolant flow into the cavity being prevented by the compressible membrane. In aspects where the air pocket (i.e., cavity 500) has no compressible membrane, longer and thinner shapes may be preferable (extending upwards) so that there is a longer space for the coolant to travel while leaving more air to act as compressible material.

In aspects where the first compressible membrane 506A is used, the first compressible membrane 506A is placed first and then coolant lines of the at least one coolant passageway 210 may be vacuumed out to avoid bubble formation in the coolant lines. The first compressible membrane 506A may be resistant to the vacuum (i.e., does not allow the vacuum to be pulled on the at least one cavity 500). In such aspects, the at least one cavity 500 may be shorter and flatter and may not have to be angled upwards because the coolant may not enter into the at least one cavity 500. In an example, the at least one cavity 500 may be perpendicular to the vertical or extend downwards as the coolant may not enter.

Referring to FIG. 5B, in another exemplary aspect, the at least one cavity 500 is formed at an angle that is inclined towards a top of the engine block 200 from the at least one coolant passageway 210. The at least one cavity 500 may be sealed by a second compressible membrane 506B from the at least one coolant passageway 210. In certain aspects, the first compressible membrane 506A and the second compressible membrane 506B may be designed to perform similar functions (and could be made of similar or different material), effectively sealing off the at least one cavity 500 while allowing for thermal expansion and contraction during the engine operation.

In an aspect, the dimensions of the at least one cavity 500 may be determined by a number of factors, which include but may not be limited to an amount of distortion of the at least one piston sleeve 208 due to the piston slap. The amount of distortion may correspond to the volume of the at least one coolant passageway 210 that will be replaced by the at least one piston sleeve 208 when it is deforming, and the amount of reduction of the pressure wave amplitude that is required to avoid the cavitation. The larger the air pocket, the larger the effect, according to Boyles equation: vl * pl = v2 * p2. In an example, vl is the volume of the air in the air pocket before the piston slap, v2 is the volume of air pocket at peak amplitude of the at least one piston sleeve 208 at the moment the at least one piston sleeve 208 swings back, V₁ₚₛ is the volume of coolant being displaced by deformation of the liner due to piston slap. This means v2 = v1 + V₁ₚₛ. Consequently, if system pressure p1 is 2 bar, the size of the air pocket at system pressure is the same as ‘V₁ₚₛ’ and vapor pressure is at 1 bar. In this case p2 would reach vapor pressure and cavitation can occur. In some aspects, the air pocket may be larger than the volume displaced by the at least one piston sleeve 208 to have a desired effect of cavitation reduction. In another example, the minimum delta between the system pressure and vapor pressure may have to be determined to calculate the minimum required size of the air pocket.

In an aspect, it is always desired to enhance engine efficiency. One way to enhance engine efficiency is to reduce the work of the coolant pump, resulting in lower system pressure pl. It has to be ensured that p2 is always higher than vapor pressure to avoid cavitation. The larger the volume v1, the lesser is the delta between p1 and p2. Therefore, system pressure may be reduced, enhancing fuel efficiency, when v1 is sized sufficiently to reduce the delta between pl and p2. Consequently, the design and size of the at least one cavity 500 may play a critical role in enhancing overall engine efficiency. By increasing the volume of the air pocket within the at least one cavity 500, the engine block 200 maintains a lower coolant pressure (p1) without approaching vapor pressure (p2), thus minimizing the risk of cavitation. A larger air pocket may allow for a smaller pressure differential between the coolant system pressure and the vapor pressure. The reduction in pressure differential may result in decreased work for coolant pump, which in tum may lower energy consumption and improve fuel efficiency.

In an aspect, the at least one cavity 500 may take any shape that entraps air (or is conducive to inclusion of other compressible material (e.g., carbon graphene monolith, and the like) while the internal combustion engine 104 is filled with coolant in the at least one coolant passageway 210. The engine block 200 may have at least one cavity per at least one piston sleeve 208 due to the proximity of the location of the at least one cavity 500 from the cavity degradation. In accordance with the present disclosure, the at least one cavity 500 may act as a compressible medium or an expandable medium by entrapping air (or other compressible and/or expandable material) within its cavity. In some aspects, the compressible medium and/or the expandable medium may act in conjunction with the first compressible membrane 506A. The compressible medium or the expandable medium may absorb pressure waves generated during operation of the internal combustion engine 104, particularly during the piston slap. During the piston slap, rapid movement of the piston 206 may compress the at least one coolant passageway 210 surrounding the at least one piston sleeve 208, creating the pressure waves that propagate through the at least one coolant passageway 210. As the pressure waves generated by the piston slap reach the vicinity of the at least one cavity 500, the air (or other compressible/expandable material) within the at least one cavity 500 may compress, absorbing a portion of the pressure energy. The compression of the air (or other material) within the at least one cavity 500 may dampen the amplitude of the pressure waves. By reducing the peak pressure at the surface of the at least one piston sleeve 208, the at least one cavity 500 may mitigate the cavitation degradation. In operation, the shape and geometry of the at least one cavity 500 may be optimized to enhance functionality as a shock absorber.

Referring to FIG. 6, according to an example of the present disclosure, the engine block 200 forms one or more cylindrical bores 600. In an exemplary aspect, the number of cylindrical bores is six. Each of the one or more cylindrical bores 600 may provide an enclosure for components which may not be limited to a combustion chamber, a piston, a piston sleeve, and a coolant. The one or more cylindrical bores 600 may dissipate heat generated during the combustion. In aspects, the one or more cylindrical bores 600 may interface with the cooling system of the internal combustion engine 104, allowing the at least one coolant passageway 210 to circulate around its external surface. According to an aspect, FIG. 6 depicts an example of a positioning or placement of the at least one cavity 500 on the engine block 200. In an example, proper positioning of the at least one cavity 500 may create a buffer zone that absorbs and mitigates pressure fluctuations of the at least one coolant passageway 210 caused by the movement of pistons inside the internal combustion engine 104. The proper positioning of the at least one cavity 500 may be determined by factors such as the frequency of piston slap, location (e.g., range) where piston slap occurs as a function of engine operating conditions, the speed at which pressure changes through the at least one coolant passageway 210, magnitude of pressure changes in coolant as a function of piston slap, and the dynamics of fluid mechanics within the internal combustion engine 104.

Referring to FIG. 7, according to an example of the present disclosure, the engine block 200 includes the one or more cylindrical bores 600. In an exemplary aspect, the number of cylindrical bores is six. Each of the one or more cylindrical bores 600 may include components which may not be limited to a combustion chamber, a piston, a piston sleeve, and a coolant. In aspects, the at least one coolant passageway 210 may circulate through the internal combustion engine 104, absorbing heat generated during the combustion process and maintaining optimal operating temperatures.

In an aspect, each of the one or more cylindrical bores 600 may include the at least one cavity 500 casted or machined in proximity to the walls of the at least one piston sleeve 208 to be placed in the internal combustion engine 104. As an example, the at least one cavity 500 can number six, where each of the at least one cavity 500 may be casted or machined in the engine block 200 of the internal combustion engine 104. Each of the six cavities may have similar placement and configurations. The cavities (e.g., six, or more, or less) in the engine block 200 may keep the pressure of the coolant consistent to prevent the pressure from dropping below the vapor pressure of the coolant. The consistency of pressure may reduce or eliminate the drop of system pressure below vapor pressure, thereby preventing cavitation.

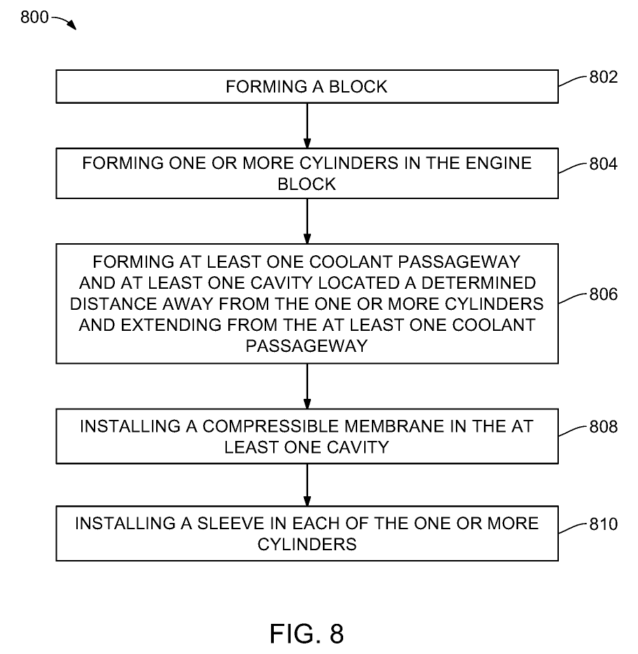

Referring to FIG. 8, an example method 800 of making an internal combustion engine 104, according to an example of the present disclosure includes one or more steps that are combined to perform the method of making the internal combustion engine 104. The method 800 will be explained in conjunction with the previous figures. Although the example utilized for method 800 depicts a particular sequence of operations, the sequence may be altered without departing from the scope of the present disclosure. For example, some of the operations depicted may be performed in parallel or in a different sequence that does not materially affect the function of the method 800. In other examples, different components of an example apparatus or system that implements the method 800 may perform functions at substantially the same time or in a specific sequence.

The method 800 begins at step 802. At step 802, the method 800 includes forming a block, such as the engine block 200. The engine block 200 may serve as the primary structural component of the internal combustion engine 104. In particular, the engine block 200 may be formed by casting or machining a block of metal, or by additive manufacturing using 3D metal printing, wherein the metal may include but is not limited to aluminum or cast iron.

The method 800, at step 804, includes forming the one or more cylinders in the engine block 200. The one or more cylinders may be formed by drilling or machining the one or more cylindrical bores 600 in the engine block 200, or by additive manufacturing using 3D metal printing. Each of the one or more cylinders in the engine block 200 may house a corresponding piston 206 which may be connected to the crankshaft 214 via connecting rod(s) 212.

Further, the method 800, at step 806, includes forming the at least one coolant passageway 210 and at least one cavity 500 located a determined distance away from the one or more cylinders and extending from the at least one coolant passageway 210. The at least one cavity 500 may be associated with the cooling system and may play a critical role in the engine efficiency as a result of consistent coolant pressure, as described previously. The at least one coolant passageway 210 and at least one cavity 500 may be formed by casting, drilling or machining the engine block 200, or by additive manufacturing using 3D metal printing.

In some aspects, the sizing and configuration of the cavities may significantly influence the engine efficiency. In an aspect, the at least one cavity 500 may include a single large cavity. In another aspect, the at least one cavity 500 may include a plurality of smaller cavities. The single large cavity of the at least cavity 500 may provide a more substantial air pocket to dampen pressure fluctuations, thereby enhancing the overall engine efficiency. Conversely, the plurality of smaller cavities of the at least one cavity 500 may achieve similar benefits by distributing the air pockets strategically throughout the engine block 200. This distribution may effectively absorb pressure waves resulting from piston slap and reduce the likelihood of cavitation, while allowing for precise tuning of the cooling system to further improve engine performance. Additionally, the at least one piston sleeve 208 may have the at least one coolant passageway 210 at least partially located at a radial distance. During operation of the internal combustion engine 104, the coolant in the at least one coolant passageway 210 may absorb heat from the walls of the engine block 200 and carry the heat to a radiator, where the excess heat is released into the surrounding air through convection.

Further, at step 808, the method 800 includes installing a compressible membrane or an expandable membrane in the at least one cavity 500. As an example, the compressible membrane may be the first compressible membrane 506A or the second compressible membrane 506B described previously. In certain aspects, the first compressible membrane 506A and the second compressible membrane 506B may be designed to perform similar functions, effectively sealing off the at least one cavity 500 while allowing for expansion and contraction of the trapped compressible/expandable material (e.g., air or other material) during the engine operation.

In aspects without the first compressible membrane 506A or the second compressible membrane 506B, it is essential not to vacuum the coolant lines of the at least one coolant passageway 210 prior to adding the coolant, as this may remove the air otherwise trapped within the at least one cavity 500. Furthermore, in such aspects where the air pocket has no compressible membrane, longer and thinner cavity of the at least cavity 500 may be preferable so that there is a longer space for the coolant to travel and leave more air to act as the compressible material.

Conversely, in cases where either the first compressible membrane 506A or the second compressible membrane 506B is present, the coolant lines may be vacuumed after entrapping the air (or other compressible/expandable material) in the at least one cavity 500. This distinction is crucial for maintaining the integrity of the air pocket and ensuring consistent pressure control within the engine block 200, thereby enhancing the overall effectiveness of the cooling system In such aspects, the at least one cavity 500 may be shorter and flatter and may not have to be angled upwards because the coolant may not enter into the at least one cavity 500. In an example, the at least one cavity 500 may be perpendicular to the vertical or even extend downwards as the coolant may not enter into the at least one cavity 500 due to its entry to the at least one cavity 500 being blocked by the compressible membrane (e.g., 506A or 506B).

Although the aspects are described with respect to installation of compressible membrane, however expandable membrane may be utilized to seal the cavities without departing from the scope of the present disclosure. In some aspects, the installed membrane may be both compressible and expandable, allowing for enhanced adaptability to dynamic operating conditions within the internal combustion engine 104. The expandable membrane may facilitate sealing in the at least one cavity 500, providing not only a barrier but also accommodating variations in volume due to expansion or contraction during engine operation. This dual functionality of being both compressible and expandable enhances the overall effectiveness of the cooling system by ensuring that the at least one cavity 500 (and contents therein) remains stable and capable of absorbing pressure fluctuations.

Finally, the method 800, at step 810, includes installing a sleeve of the at least one piston sleeve 208 in each of the one or more cylinders. In an aspect, the at least one piston sleeve 208 may be installed into a respective one of the one or more cylinders where the at least one piston sleeve 208 may receive a corresponding piston 206. The at least one piston sleeve 208 may be sealed to prevent leakage and maintain compression within the cylinders. The installation of the at least one piston sleeve 208 at step 810 not only facilitates the precise placement of the piston 206 within each cylinder but also ensures an effective seal that prevents leakage and maintains the necessary compression for optimal engine performance.

The aspects discussed in the present disclosure pertaining to methods and systems that facilitate prevention or avoidance of cavitation degradation on liner walls of internal combustion engines, offer several significant advantages. By integrating a strategically positioned cavity or cavities within the engine block, the disclosed systems may effectively absorb and mitigate the pressure waves generated during piston slap and rapid changes in engine dynamics. The inclusion of cavities provides a compressible membrane that dampens the amplitude of pressure fluctuations, thereby reducing the risk of cavitation and subsequent erosive degradation to piston sleeves. This proactive approach enhances the longevity and reliability of the engine by minimizing wear and tear on critical components. Additionally, by preventing cavitation-induced engine degradation and extending the operational life of engine liners, these methods not only reduce maintenance costs but also enhance overall engine performance and efficiency.

For purposes of this disclosure, any arrangement of components to achieve the same functionality is effectively "associated" such that the desired functionality is achieved. Hence, any two components herein combined to achieve a particular functionality can be seen as "associated with" each other such that the desired functionality is achieved, irrespective of architectures or intermedial components. Likewise, any two components so associated can also be viewed as being "operably connected" or "operably coupled" to each other to achieve the desired functionality, and any two components capable of being so associated can also be viewed as being "operably couplable" to each other to achieve the desired functionality. Some examples of operably couplable include, but are not limited to, physically interacting components and/or wirelessly interactable and/or wirelessly interacting components and/or logically interacting and/or logically interactable components. Furthermore, it will be understood that a component preceding the term "of the" may be disposed at any practicable location (e.g., on, within, and/or externally disposed from the vehicle 100) such that the component may function in any manner described herein.

The foregoing discussion of the disclosure has been presented for purposes of illustration and description. The foregoing is not intended to limit the disclosure to the form or forms disclosed herein. In the foregoing detailed description for example, various features of the disclosure are grouped together in one or more examples, configurations, or aspects for the purpose of streamlining the disclosure. The features of the examples, configurations, or aspects of the disclosure may be combined in alternate examples, configurations, or aspects other than those described above. Hence, the present disclosure and drawings should not be considered in a limiting sense, as it is understood that an disclosure presented within a disclosure is in no way limited to those examples specifically illustrated.

Accordingly, the above description and any accompanying drawings, illustrations, and figures are intended to be illustrative but not restrictive. The scope of any disclosure presented within this disclosure should, therefore, be determined not with simple reference to the above description and those examples shown in the figures, but instead should be determined with reference to the pending claims along with their full scope or equivalents.

Also, though the description of the disclosure has included description of one or more examples, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative examples, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. An internal combustion engine, comprising:
an engine block including one or more cylinders;
at least one piston sleeve installed into a respective one of the one or more cylinders, wherein each of the at least one piston sleeve receives a corresponding piston;
at least one coolant passageway at least partially formed in the engine block; and
at least one cavity formed in the engine block, each of the at least one cavity being associated with a respective one of the at least one piston sleeve, wherein the at least one cavity is in fluid communication with the at least one coolant passageway.

2. The internal combustion engine of claim 1, wherein the at least one cavity is formed in a direction away from the at least one coolant passageway.

3. The internal combustion engine of claim 1, wherein at least a portion of the at least one cavity is located at a radial distance from an outer wall of the at least one piston sleeve.

4. The internal combustion engine of claim 1, wherein the at least one cavity includes a portion that is perpendicular to the at least one coolant passageway.

5. The internal combustion engine of claim 1, wherein the at least one cavity includes a compressible membrane to seal the at least one cavity, such that a portion of the compressible membrane is in fluid communication with the at least one coolant passageway.

6. The internal combustion engine of claim 5, further comprising a protective membrane placed between the compressible membrane and the at least one coolant passageway.

7. The internal combustion engine of claim 5, wherein the at least one cavity contains a compressible material on a sealed side of the compressible membrane, such that the sealed side is opposite to a side of the compressible membrane that is in fluid communication with the at least one coolant passageway.

8. The internal combustion engine of claim 7, wherein the compressible material is air.

9. The internal combustion engine of claim 1, wherein the at least one cavity is sealed by an expandable membrane, such that a portion of the expandable membrane is in fluid communication with the at least one coolant passageway.

10. The internal combustion engine of claim 1, wherein the at least one cavity comprises a plurality of cavities.

11. An engine block, comprising:
one or more cylinders formed in the engine block, wherein the one or more cylinders receive a respective piston sleeve;
at least one coolant passageway at least partially formed in the engine block; and
at least one cavity formed in the engine block, each of the at least one cavity being associated with the respective piston sleeve, wherein the at least one cavity is in fluid communication with the at least one coolant passageway.

12. The engine block of claim 11, wherein the at least one cavity is formed in a direction away from the at least one coolant passageway.

13. The engine block of claim 11, wherein at least a portion of the at least one cavity is located at a radial distance from an outer wall of the respective piston sleeve.

14. The engine block of claim 11, wherein the at least one cavity includes a portion that is perpendicular to the at least one coolant passageway.

15. The engine block of claim 11, wherein the at least one cavity is sealed by a compressible membrane, such that a portion of the compressible membrane is in fluid communication with the at least one coolant passageway.

16. A method of making an internal combustion engine, comprising:
forming a block;
forming one or more cylinders in the block; and
forming at least one coolant passageway and at least one cavity located a distance away from the one or more cylinders and extending from the at least one coolant passageway.

17. The method of claim 16, further comprising installing a sleeve in each of the one or more cylinders.

18. The method of claim 16, further comprising installing a compressible and/or expandable membrane in the at least one cavity.

19. The method of claim 18, further comprising placing a protective membrane between the compressible membrane and the at least one coolant passageway.

20. The method of claim 16, wherein forming the at least one cavity comprises positioning the at least one cavity inside a defined piston slap range within the engine block.
